(19) United States
(12) Patent Application Publication
(10) Pub. No.: US 2022/0004042 A1
(43) Pub. Date: Jan. 6, 2022

(54) DISPLAY PANEL AND DISPLAY DEVICE

(71) Applicant: HKC Corporation Limited, Shenzhen (CN)

(72) Inventor: CHUAN WU, Chongqing (CN)

(21) Appl. No.: 16/349,612

(22) PCT Filed: Nov. 15, 2018
(86) PCT No.: PCT/CN2018/115607

§ 371 Date: May 14, 2019

(30) Foreign Application Priority Data
Oct. 31, 2018 (CN) 201821789676.3

(51) Int. Cl. G02F 1/1339; G02F 1/1335

(52) U.S. Cl. CPC G02F 1/13394; G02F 1/133512; G02F 1/13396; G02F 1/133514

(57) ABSTRACT

The present application discloses a display panel and a display device. The display panel includes a first substrate, a first photo spacer, and a second photo spacer, where the first photo spacer and the second photo spacer are disposed on the first substrate. The first photo spacer includes a first photo spacer basic layer and a second photo spacer basic layer which are stacked; and the second photo spacer includes a first photo spacer basic layer.

The present application claims priority to Chinese Patent Application No. CN201821789676.3, filed with National Intellectual Property Administration, PRC on Oct. 31, 2018, and entitled “DISPLAY PANEL AND DISPLAY DEVICE”, which is incorporated herein by reference in its entirety.

### TECHNICAL FIELD

The present application relates to the technical field of display, and in particular, to a display panel and a display device.

### BACKGROUND

The statements herein merely provide background information related to the present application and do not necessarily constitute the prior art.

With the development and advancement of technology, liquid crystal displays have become mainstream display products due to their thin bodies, power saving and low radiation, etc., and have been widely used. Most of the liquid crystal displays on the market are backlight type liquid crystal displays which each include a liquid crystal panel and a backlight module. The working principle of the liquid crystal panel is that liquid crystal molecules are placed between two parallel glass substrates and a driving voltage is applied on the two glass substrates to control the rotating direction of the liquid crystal molecules, so as to refract light of the backlight module to generate a picture.

In a color filter (CF) substrate manufacture process of a liquid crystal panel, a photo spacer (PS) is prepared on the CF substrate to support a gap between the CF substrate and a thin film transistor (TFT) substrate after cell alignment of the two, and a gap height between the two is called a cell gap. The PS is formed by exposure and development using a separate photomask, so that not only is time consumed, but also the photomask is high in cost.

### SUMMARY

An objective of the present application is to provide a display panel and a display device, to solve a problem that a photomask is high in cost_to handle a case with high photomask costs.

To achieve the above objective, the present application provides a display panel including a first substrate, a first color filter, a second color filter, a third color filter, a first photo spacer, and a second photo spacer, where the first color filter, the second color filter, and the third color filter are disposed on the first substrate; and the first photo spacer and the second photo spacer form a segment gap; where the first photo spacer includes a first photo spacer basic layer and a second photo spacer basic layer which are stacked: the second photo spacer includes a first photo spacer basic layer; where the first color filter and the first photo spacer basic layer are formed at a same layer; and the second color filter and the second photo spacer basic layer are formed at a same layer.

Optionally, the first photo spacer also includes a third photo spacer basic layer stacked with the first photo spacer basic layer and the second photo spacer basic layer; the third color filter and the third photo spacer basic layer are formed at a same layer; and the second photo spacer also includes a second photo spacer basic layer stacked with the first photo spacer basic layer.

Optionally, the display panel also includes a third photo spacer, and the third photo spacer includes a first photo spacer basic layer; and the third photo spacer forms segment gaps with the first photo spacer and the second photo spacer respectively.

Optionally, a middle portion of the third photo spacer basic layer of the first photo spacer is protruding out of two sides, and the middle portion respectively forms step structures with the two sides; a length of the first photo spacer basic layer of the first photo spacer is equal to that of the second photo spacer basic layer of the first photo spacer, and the length of the first photo spacer basic layer of the first photo spacer is smaller than that of a middle portion of the third photo spacer basic layer of the first photo spacer.

Optionally, a length of the first photo spacer basic layer of the second photo spacer is greater than that of the second photo spacer basic layer.

Optionally, a middle portion of the second photo spacer basic layer of the second photo spacer is protruding out of two sides, and the middle portion respectively forms step structures with the two sides: and a length of the first photo spacer basic layer of the second photo spacer is equal to that of the middle portion of the second photo spacer basic layer.

Optionally, the third photo spacer includes a second photo spacer basic layer, and the second photo spacer basic layer can be formed at the same time when the second color filter is formed.

Optionally, the display panel also includes a black matrix, and the black matrix is disposed on the first substrate; and the first photo spacer and the second photo spacer are formed on the black matrix respectively.

The present application discloses a display panel including a first substrate, a first color filter, a second color filter, a third color filter, a first photo spacer, a second photo spacer, and a third photo spacer, where the first color filter, the second color filter, and the third color filter are disposed on the first substrate; and the first photo spacer, the second photo spacer, and the third photo spacer form segment gaps; where the first photo spacer includes a first photo spacer basic layer, a second photo spacer basic layer, and a third photo spacer basic layer which are stacked; where a middle portion of the third photo spacer basic layer of the first photo spacer is protruding out of two sides, and the middle portion respectively forms step structures with the two sides; a length of the first photo spacer basic layer of the first photo spacer is equal to that of the second photo spacer basic layer of the first photo spacer, and the length of the first photo spacer basic layer of the first photo spacer is smaller than that of a middle portion of the third photo spacer basic layer of the first photo spacer; the second photo spacer includes a first photo spacer basic layer and a second photo spacer basic layer which are stacked; a length of the first photo spacer basic layer of the second photo spacer is greater than that of the second photo spacer basic layer; the third photo spacer includes a second photo spacer basic layer, where the first color filter and the first photo spacer basic layer are formed at a same layer; the second color filter and the second photo spacer basic layer are formed at a same layer; the third color filter and the third photo spacer basic layer are formed at a same layer; the display panel also includes a black matrix, and the black matrix is disposed on the first substrate; and the first photo spacer, the second photo spacer, and the third photo spacer are respectively formed on the black matrix.

The present application also discloses a display device including the display panel as described above.

In a first substrate manufacture process of a display panel, a photo spacer (PS) is prepared on the first substrate to support a gap between the first substrate and a second substrate, and a gap height between the two is called a cell gap. The first substrate needs to form a first color filter, a second color filter, and a third color filter first before forming the photo spacer. The photo spacer is formed by exposure and development using a separate photomask, so that not only is time consumed, but also a photomask is high in cost. In this solution, the first color filter and the first photo spacer basic layer are formed at a same layer through a same photomask; the second color filter and the second photo spacer basic layer are formed at a same layer through a same photomask; no additional separate photo spacer process is used, which saves time, and the photo spacer is no longer formed by exposure and development through a separate mask, which saves a photomask and reduces production costs.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic vertical view of a display panel according to an embodiment of the present application;

FIG. 2 is a schematic view of an A-A′ direction cross section of a display panel with an additional photo spacer according to an embodiment of the present application;

FIG. 3 is a schematic view of an embodiment of the present application after cell alignment;

FIG. 4 is a schematic vertical view of a display panel according to an embodiment of the present application;

FIG. 5 is a schematic view (1) of a cross section of a display panel according to an embodiment of the present application;

FIG. 6 is a schematic view of a B-B′ cross section of a display panel according to an embodiment of the present application;

FIG. 7 is a schematic view (2) of an A-A′ direction cross section of a display panel according to an embodiment of the present application;

FIG. 8 is a schematic view of a process of a display panel according to an embodiment of the present application; and

FIG. 9 is a schematic view of a display device according to an embodiment of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms “first”, “second” are merely for a descriptive purpose, and cannot to be understood to indicate or imply relative importance, or implicitly indicate the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

The present application will be further described below with reference to the accompanying drawings and optional embodiments.

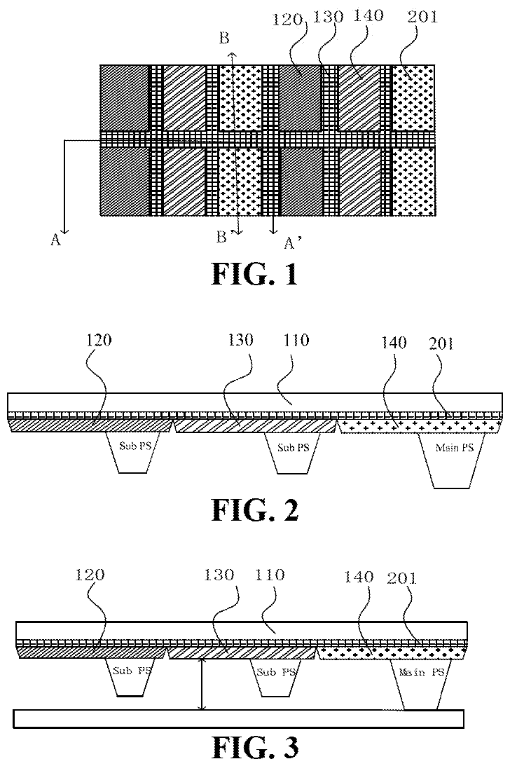

Referring to FIG. 1, FIG. 2 and FIG. 3, in a color filter (CF) substrate process of a display panel, a photo spacer (PS) is prepared on a CF substrate to support a gap between the CF substrate and a TFT substrate after the cell alignment of the two, and a gap height between the two is called a cell gap; and a liquid crystal cell is filled with liquid crystals before a liquid crystal panel is formed. In the production of the liquid crystal panel, sub spacers (sub PSs) are formed. Under normal conditions, the sub PSs are suspended, and a supporting effect is achieved directly through by a main PS. Under the conditions that the panel is pressed, the sub PSs have a supporting effect, so that it can be ensured that the panel can also be supported when pressed. The liquid crystal cell has a certain elasticity, so that the liquid crystals placed in the liquid crystal cell have a large range of upper and lower limits. If there are too many liquid crystals, the gravity is uneven; and if there are too few liquid crystals, bubbles occur, which is also called LC margin. Under normal circumstances, the LC margin with a large PS gap is large, which can improve production yield and enhance product quality for production. In the PS design, the main PS and the sub PSs generally use a half tone mask (HTM) or a gray tone mask (GTM) to make a PS gap at the CF side, but the price of an HTM/GTM mask is expensive, so that the production cost is higher, and it is not easy to control a high end of the gap.

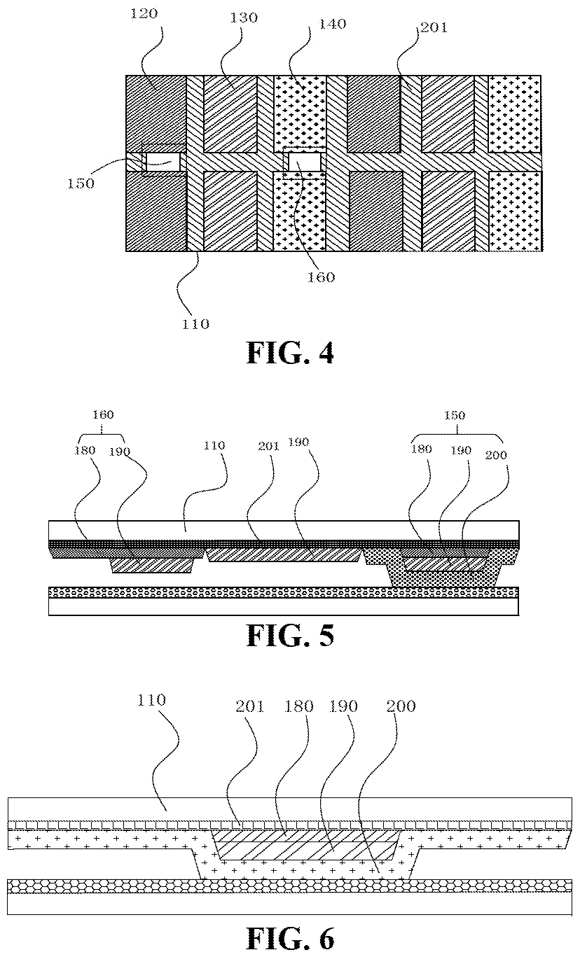

A display panel 101 is exemplified by a liquid crystal display panel 101. Referring to FIG. 4, an embodiment of the present application discloses a display panel 101 including a first substrate 110, a first color filter 120, a second color filter 130, a third color filter 140, a first photo spacer 150, and a second photo spacer 160, where the first color filter 120, the second color filter 130, and the third color filter 140 are disposed on the first substrate 110; and the first photo spacer 150 and the second photo spacer 160 form a segment gap;

the first photo spacer 150 includes a first photo spacer basic layer 180 and a second photo spacer basic layer 190 which are stacked: and the second photo spacer 160 includes a first photo spacer basic layer 180;

the first color filter 120 and the first photo spacer basic layer 180 are formed at a same layer; and the second color filter 130 and the second photo spacer basic layer 190 are formed at a same layer.

In the first substrate 110 manufacture process of the display panel 101, a photo spacer (PS) needs to be prepared on the first substrate 110 to support a gap between the first substrate 110 and a second substrate after cell alignment between the two, and a gap height between the two is called a cell gap. The first substrate 110 needs to form a first color filter 120, a second color filter 130, and a third color filter 140 first before forming the photo spacer. The photo spacer is formed by exposure and development using a separate photomask, so that not only is time consumed, but also a photomask is high in cost. In this solution, the first color filter 120 and the first photo spacer basic layer 180 are formed at a same layer through a same photomask; the second color filter 130 and the second photo spacer basic layer 190 are formed at a same layer through a same photomask; no additional separate photo spacer process is used, which saves time, and the photo spacer is no longer formed by exposure and development through a separate mask, which saves a photomask and reduces production costs.

In one or more embodiments, the first photo spacer 150 also includes a third photo spacer basic layer 200 stacked with the first photo spacer basic layer 180 and the second photo spacer basic layer 190; the third color filter 140 and the third photo spacer basic layer 200 are formed at a same layer; the second photo spacer 160 also includes a second photo spacer basic layer 190 stacked with the first photo spacer basic layer 180.

In this solution, the first photo spacer 150 also includes a third photo spacer basic layer 200; the first photo spacer basic layer 180, the second photo spacer basic layer 160, and the third photo spacer basic layer 200 are stacked, there are the minimum requirements for a cell gap of a liquid crystal cell; the first color filter 120, the second color filter 130, and the third color filter 140 are small in film thickness; and the first photo spacer 150 is arranged to be three stacked layers, which makes it easier to make the thickness of the first photo spacer 150 meet the minimum requirements for the cell gap of the liquid crystal cell. If there are only two layers, the film thickness of the filter needs to be increased, which has an impact on transmittance.

In one or more embodiments, the display panel 101 also includes a third photo spacer 170, and the third photo spacer 170 includes a first photo spacer basic layer 180; and the third photo spacer 170 forms segment gaps with the first photo spacer 150 and the second photo spacer 160 respectively.

In this solution, the display panel 101 also includes a third photo spacer 170; the third photo spacer 170 forms two segment gaps with the first photo spacer 150 and the second photo spacer 160 respectively; the first photo spacer basic layer 180, the second photo spacer basic layer 190, and the third photo spacer basic layer 200 which are stacked are taken as the first photo spacer 150: the first photo spacer basic layer 180 and the second photo spacer basic layer 190 which are stacked are taken as the second photo spacer 160, so that after the cell alignment of the panel, the first photo spacer 150 is formed to support the cell gap while the second photo spacer 160 and the third photo spacer 170 are suspended; when the display panel 101 is subjected to a smaller pressure, the first photo spacer acts; when the display panel 101 is subjected to a slightly greater pressure, the second photo spacer 160 acts; when the display panel 101 is subjected to a much greater pressure, the third photo spacer 170 acts, so that the display panel 101 has a better elastic range and larger upper and lower limits of liquid crystal capacity; thus, the liquid crystal (LC) margin of the product can be improved, the production yield can be improved, and the product quality can be improved. The first photo spacer 150 and the second photo spacer 160 form a segment gap; the first photo spacer basic layer 180 and the second photo spacer basic layer 190 which are stacked are taken as a first supporting object, and the photo spacer basic layer 180 is taken as a second supporting object, so that after the cell alignment of the panel, the first supporting object forms a cell gap and the second supporting object is suspended; only when the panel is pressed will the second supporting object act; the liquid crystal cell has a certain elasticity such that the liquid crystals contained in the liquid crystal cell have upper and lower limits in a larger range, which can improve the LC margin of the product, enhance production yield, and improve product quality.

In one or more embodiments, a middle portion of the third photo spacer basic layer 200 of the first photo spacer 150 is protruding out of two sides, and the middle portion respectively forms step structures with the two sides; a length of the first photo spacer basic layer 180 of the first photo spacer 150 is equal to that of the second photo spacer basic layer 190 of the first photo spacer 150, and the length of the first photo spacer basic layer 180 of the first photo spacer 150 is smaller than that of a middle portion of the third photo spacer basic layer 200 of the first photo spacer 150.

In one or more embodiments, a length of the first photo spacer basic layer 180 of the second photo spacer 160 is greater than that of the second photo spacer basic layer 190.

In this solution, the length of the first photo spacer basic layer 180 of the second photo spacer 160 is greater than that of the second photo spacer basic layer 190, which expands a space of liquid crystal capacity and ensures product yield as compared to a situation where the length of the first photo spacer basic layer 180 is set to be equal to that of the second photo spacer basic layer 190.

In one or more embodiments, a middle portion of the second photo spacer basic layer 190 of the second photo spacer 160 is protruding out of two sides, and the middle portion respectively forms step structures with the two sides: and a length of the first photo spacer of the second photo spacer 160 is equal to that of the middle portion of the second photo spacer 160 basic layer.

In this solution, the middle portion of the second photo spacer basic layer 190 of the second photo spacer 160 respectively forms the step structures with the two sides; the middle portion of the second photo spacer basic layer can maintain the liquid crystal cell gap of the display panel 101 under normal conditions, and the two sides which form the step shapes with the middle portion of the second photo spacer basic layer can limit a pressure distance under external pressure, so as to improve pressure resistance of the display panel 101.

In one or more embodiments, the third photo spacer 170 includes a second photo spacer basic layer 190, and the second photo spacer basic layer 190 can be formed at the same time when the second color filter 130 is formed.

The second photo spacer basic layer 190 can be formed at the same time when the second color filter 130 is formed, thereby saving a process.

In one or more embodiments, the display panel 101 also includes a black matrix 201, and the black matrix 201 is disposed on a first substrate 110;

a first photo spacer 150 and a second photo spacer 160 are formed on the black matrix 201 respectively.

In this solution, the first photo spacer 150 and the second photo spacer 160 are formed on the black matrix 201 respectively, thereby achieving a better shading effect.

In one or more embodiments, referring to FIG. 4 to FIG. 7, a display panel 101 is disclosed, including a first substrate 110, a first color filter 120, a second color filter 130, a third color filter 140, a first photo spacer 150, a second photo spacer 160, and a third photo spacer 170, where the first color filter 120, the second color filter 130, and the third color filter 140 are disposed on the first substrate 110; and the first photo spacer 150, the second photo spacer 160, and the third photo spacer 170 form segment gaps;

the first photo spacer 150 includes a first photo spacer basic layer 180, a second photo spacer basic layer 190, and a third photo spacer basic layer 200 which are stacked:

a middle portion of the third photo spacer basic layer 200 of the first photo spacer 150 is protruding out of two sides, and the middle portion respectively forms step structures with the two sides; a length of the first photo spacer basic layer 180 of the first photo spacer 150 is equal to that of the second photo spacer basic layer 190 of the first photo spacer 150, and the length of the first photo spacer basic layer 180 of the first photo spacer 150 is smaller than that of a middle portion of the third photo spacer basic layer 200 of the first photo spacer 150;

the second photo spacer 160 includes a first photo spacer basic layer 180 and a second photo spacer basic layer 190 which are stacked;

a length of the first photo spacer basic layer 180 of the second photo spacer 160 is greater than that of the second photo spacer basic layer 190;

the second photo spacer 170 includes a second photo spacer basic layer 190;

the first color filter 120 and the first photo spacer basic layer 180 are formed at a same layer: the second color filter 130 and the second photo spacer basic layer 190 are formed at a same layer: the third color filter 140 and the third photo spacer basic layer 200 are formed at a same layer;

the display panel 101 also includes a black matrix 201, and the black matrix 201 is disposed on a first substrate 110; and

the first photo spacer 150, the second photo spacer 160, and the third photo spacer 170 are formed on the black matrix 201 respectively.

The first photo spacer basic layer 180, the second photo spacer basic layer 190, and the third photo spacer basic layer 200 have different colors.

In the first substrate 110 manufacture process of the display panel 101, a photo spacer (PS) is prepared on the first substrate 110 to support a gap between the first substrate 110 and a second substrate after the cell alignment between the two, and a gap height between the two is called a cell gap. The first substrate 110 needs to form a first color filter 120, a second color filter 130, and a third color filter 140 first before forming the photo spacer. The photo spacer is formed by exposure and development using a separate photomask, so that not only is time consumed, but also a photomask is high in cost. In this solution, the first color filter 120 and the first photo spacer basic layer 180 are formed at a same layer through a same photomask; the second color filter 130 and the second photo spacer basic layer 190 are formed at a same layer through a same photomask; no additional separate photo spacer process is used, which saves time, and the photo spacer is no longer formed by exposure and development through a separate mask, which saves a photomask and reduces production costs.

Referring to FIG. 5 and FIG. 8, an embodiment of the present application discloses a method for manufacturing a display panel 101, including the following steps:

S81: Cleaning glass;

S82: Performing black matrix preparation to form a black matrix 201;

S83: Preparing a first color filter; in the step of preparing the first color filter, first coat an entire area with a first photoresist material, such as a red photoresist material to form a red photoresist basic layer, and through exposure and development, synchronously form a red color filter and a red photo spacer basic layer 180 of a first photo spacer, as well as a red photo spacer basic layer 180 of a second photo spacer 160. The red filter is located in a hollowed-out area formed by the black matrix, and the first photo spacer and the red photo spacer basic layer of the second photo spacer are formed on the black matrix:

S84: Preparing a second color filter; in the step of preparing the second color filter, first coat an entire area with a second photoresist material, such as a green photoresist material to form a green photoresist basic layer, and perform exposure and development to synchronously form a green color filter 130, a green photo spacer basic layer 190 of the first photo spacer, and a green photo spacer basic layer 190 of the second photo spacer 160, as well as a green photo spacer basic layer 190 of the third photo spacer 170; where the green color filter is located in the hollowed-out area formed by the black matrix; and the green photo spacer basic layers of the first photo spacer, the second photo spacer, and the photo spacer are formed on the black matrix;

S85: Preparing a third color filter; in the step of preparing the third color filter, first coat an entire area with a third photoresist material, such as a blue photoresist material to form a blue photoresist basic layer, and perform exposure and development to form a third color filter 140 and a blue photo spacer basic layer 200 of the first photo spacer; where the blue color filter is located in the hollowed-out area formed by the black matrix; and the blue photo spacer basic layer is formed on the black matrix;

S86: Preparing a transparent electrode layer;

The first photo spacer, the second photo spacer 160, and the third photo spacer 170 are formed above the black matrix 201 respectively.

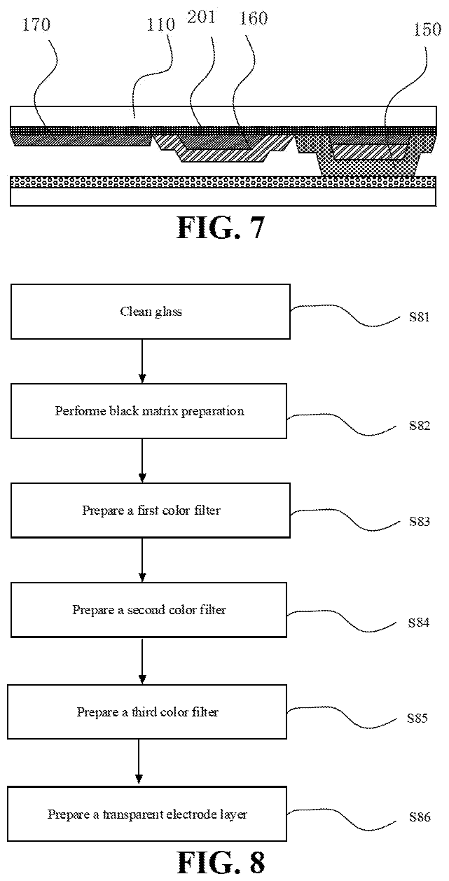

As an embodiment of the present application, referring to FIG. 7 and FIG. 8, a method for manufacturing a display panel 101 includes the following steps:

S81: Canning glass;

S82: Performing black matrix preparation to form a black matrix 201;

S83: Preparing a first color filter; in the step of preparing the first color filter, first coat an entire area with a first photoresist material, such as a red photoresist material to form a red photoresist basic layer, and perform exposure and development to synchronously form a red color filter 120, a red photo spacer basic layer 180 of a first photo spacer, and a red photo spacer basic layer 180 of a second photo spacer 160, as well as a red photo spacer basic layer 180 of a third photo spacer 170;

S84: Preparing a second color filter; in the step of preparing the second color filter, first coat an entire area with a second photoresist material, such as a green photoresist material to form a green photoresist basic layer, and perform exposure and development to synchronously form a green color filter 130 and a green photo spacer basic layer 190 of the first photo spacer, as well as a green photo spacer basic layer 190 of the second photo spacer 160;

S85: Preparing a third color filter; in the step of preparing the third color filter, first coat an entire area with a third photoresist material, such as a blue photoresist material to form a blue photoresist basic layer, and perform exposure and development to form a blue color filter 140 and a blue photo spacer basic layer 200 of the first photo spacer 150;

S86: Preparing a transparent electrode layer.

The first photo spacer 150, the second photo spacer 160, and the third photo spacer 170 are formed above the black matrix 201 respectively; and the red color filter, the green color filter, and the blue color filter are located in the hollowed-out area formed by the black matrix.

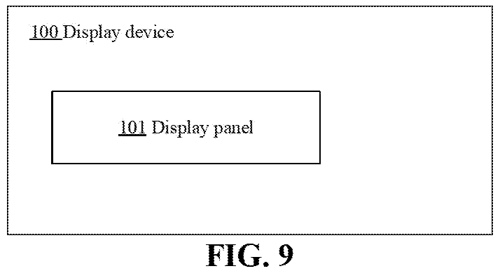

As an embodiment of the present application, referring to FIG. 9, a display device 100 is disclosed, including the display panel 101 as described above.

The panel of the present application may be a twisted nematic (TN) panel, an in-plane switching (IPS) panel, or a multi-domain vertical alignment (VA) panel, and of course, the panel may also be other types of panels, as long as the panels are suitable.

The above are further detailed descriptions of the present application in conjunction with the specific optional embodiments, but the specific implementation of the present application cannot be determined as limited to these descriptions. For a person of ordinary skill in the art to which the present application pertains, a number of simple deductions or substitutions may also be made without departing from the concept of the present application. All these should be considered as falling within the scope of protection of the present application.

What is claimed is:

1. A display panel, comprising a first substrate, a first color filter, a second color filter, a third color filter, a first photo spacer, and a second photo spacer, wherein the first color filter, the second color filter, and the third color filter are disposed on the first substrate; and the first photo spacer and the second photo spacer form a segment gap;
wherein the first photo spacer comprises a first photo spacer basic layer and a second photo spacer basic layer which are stacked;
the second photo spacer comprises a first photo spacer basic layer;
wherein the first color filter and the first photo spacer basic layer are formed at a same layer; and
the second color filter and the second photo spacer basic layer are formed at a same layer.

2. The display panel according to claim 1, wherein the first photo spacer also comprises a third photo spacer basic layer stacked with the first photo spacer basic layer and the second photo spacer basic layer; the third color filter and the third photo spacer basic layer are formed at a same layer; and
the second photo spacer also comprises a second photo spacer basic layer stacked with the first photo spacer basic layer.

3. The display panel according to claim 2, wherein the display panel also comprises a third photo spacer, and the third photo spacer comprises a first photo spacer basic layer; and
the third photo spacer forms segment gaps with the first photo spacer and the second photo spacer respectively.

4. The display panel according to claim 3, wherein a middle portion of the third photo spacer basic layer of the first photo spacer is protruding out of two sides, and the middle portion respectively forms step structures with the two sides; a length of the first photo spacer basic layer of the first photo spacer is equal to that of the second photo spacer basic layer of the first photo spacer, and the length of the first photo spacer basic layer of the first photo spacer is smaller than that of a middle portion of the third photo spacer basic layer of the first photo spacer.

5. The display panel according to claim 3, wherein a length of the first photo spacer basic layer of the second photo spacer is greater than that of the second photo spacer basic layer.

6. The display panel according to claim 3, wherein a middle portion of the second photo spacer basic layer of the second photo spacer is protruding out of two sides, and the middle portion respectively forms step structures with the two sides; and a length of the first photo spacer basic layer of the second photo spacer is equal to that of the middle portion of the second photo spacer basic layer.

7. The display panel according to claim 3, wherein the third photo spacer comprises a second photo spacer basic layer, and the second photo spacer basic layer can be formed at the same time when the second color filter is formed.

8. The display panel according to claim 1, wherein the display panel also comprises a black matrix, and the black matrix is disposed on the first substrate; and
the first photo spacer and the second photo spacer are formed on the black matrix respectively.

9. A display panel, comprising a first substrate, a first color filter, a second color filter, a third color filter, a first photo spacer, a second photo spacer, and a third photo spacer, wherein the first color filter, the second color filter, and the third color filter are disposed on the first substrate; and the first photo spacer, the second photo spacer, and the third photo spacer form segment gaps;
wherein the first photo spacer comprises a first photo spacer basic layer, a second photo spacer basic layer, and a third photo spacer basic layer which are stacked;
a middle portion of the third photo spacer basic layer of the first photo spacer is protruding out of two sides, and the middle portion respectively forms step structures with the two sides; a length of the first photo spacer basic layer of the first photo spacer is equal to that of the second photo spacer basic layer of the first photo spacer, and the length of the first photo spacer basic layer of the first photo spacer is smaller than that of a middle portion of the third photo spacer basic layer of the first photo spacer;
the second photo spacer comprises a first photo spacer basic layer and a second photo spacer basic layer which are stacked;
a length of the first photo spacer basic layer of the second photo spacer is greater than that of the second photo spacer basic layer;
the third photo spacer comprises a second photo spacer basic layer;
wherein the first color filter and the first photo spacer basic layer are formed at a same layer; the second color filter and the second photo spacer basic layer are formed at a same layer; the third color filter and the third photo spacer basic layer are formed at a same layer;
the display panel also comprises a black matrix, and the black matrix is disposed on the first substrate; and
the first photo spacer, the second photo spacer, and the third photo spacer are respectively formed on the black matrix.

10. A display device, comprising a display panel, wherein the display panel comprises a first substrate, a first color filter, a second color filter, a third color filter, a first photo spacer, and a second photo spacer, wherein the first color filter, the second color filter, and the third color filter are disposed on the first substrate; and the first photo spacer and the second photo spacer form a segment gap;
wherein the first photo spacer comprises a first photo spacer basic layer and a second photo spacer basic layer which are stacked;
the second photo spacer comprises a first photo spacer basic layer;
wherein the first color filter and the first photo spacer basic layer are formed at a same layer; and
the second color filter and the second photo spacer basic layer are formed at a same layer.

11. The display device according to claim 10, wherein the first photo spacer also comprises a third photo spacer basic layer stacked with the first photo spacer basic layer and the second photo spacer basic layer; the third color filter and the third photo spacer basic layer are formed at a same layer; and
the second photo spacer also comprises a second photo spacer basic layer stacked with the first photo spacer basic layer.

12. The display device according to claim 11, wherein the display panel also comprises a third photo spacer, and the third photo spacer comprises a first photo spacer basic layer; and the third photo spacer forms segment gaps with the first photo spacer and the second photo spacer respectively.

13. The display device according to claim 12, wherein a middle portion of the third photo spacer basic layer of the first photo spacer is protruding out of two sides, and the middle portion respectively forms step structures with the two sides; a length of the first photo spacer basic layer of the first photo spacer is equal to that of the second photo spacer basic layer of the first photo spacer, and the length of the first photo spacer basic layer of the first photo spacer is smaller than that of a middle portion of the third photo spacer basic layer of the first photo spacer.

14. The display device according to claim 12, wherein a length of the first photo spacer basic layer of the second photo spacer is greater than that of the second photo spacer basic layer.

15. The display device according to claim 12, wherein a middle portion of the second photo spacer basic layer of the second photo spacer is protruding out of two sides, and the middle portion respectively forms step structures with the two sides; and a length of the first photo spacer basic layer of the second photo spacer is equal to that of the middle portion of the second photo spacer basic layer.

16. The display device according to claim 12, wherein the third photo spacer comprises a second photo spacer basic layer, and the second photo spacer basic layer can be formed at the same time when the second color filter is formed.

17. The display device according to claim 10, wherein the display panel also comprises a black matrix, and the black matrix is disposed on the first substrate; and
the first photo spacer and the second photo spacer are formed on the black matrix respectively.
